(19) United States
(12) Patent Application Publication
(10) Pub. No.: US 2016/0363110 A1
(43) Pub. Date: Dec. 15, 2016

(54) SENSOR DEVICE FOR A FLUID FLOW MACHINE

(71) Applicant: Rolls-Royce Deutschland Ltd & Co KG, Blankenfelde-Mahlow (DE)

(72) Inventors: Peter HOEHNE, Fredersdorf (DE); Frank SCHROER, Berlin (DE)

(21) Appl. No.: 15/178,739

(22) Filed: Jun. 10, 2016

(30) Foreign Application Priority Data
Jun. 10, 2015 (DE) 10 2015 210 636.5

(51) Int. Cl. F02P 17/12

(52) U.S. Cl. CPC F02P 17/12

(57) ABSTRACT

A measuring device for a measurement quantity is provided. The measuring device includes, an electronic measuring unit provided and designed to capture at least one measurement signal of an ignition electrode, which is arranged at least partially in a combustion chamber of a fluid-flow machine, the measurement signal being dependent on the measurement quantity. At least one protective device is provided to protect at least the electronic measuring unit from high voltages.

### REFERENCE TO RELATED APPLICATION

This application claims priority to German Patent Application No. 10 2015 210 636.5 filed on Jun. 10, 2015, the entirety of which is incorporated by reference herein.

### BACKGROUND

This invention relates to a measuring device for a measurement quantity.

A measuring device of this type includes an electronic measuring unit provided and designed to capture at least one measurement signal of an ignition electrode. This ignition electrode is arranged in a combustion chamber of a fluid-flow machine. The measurement signal is dependent on the measurement quantity. An ignition electrode of this type can for example be an ignition electrode for a combustion chamber of an aircraft engine.

It is known from DE 10 2011 087 599 A1 that an ignition electrode can be used for example for ion current measurement. Measurement with the ignition electrode is however only possible in this case when the ignition electrode is deactivated: this is because ignition voltages for fluid-flow machines can be several 1000 V. A high voltage like this can destroy a sensitive electronic measuring unit of a measuring device. Furthermore, the quantity to be measured is restricted to the ion current.

### SUMMARY

An object is to provide a measuring device using which measurement quantities of an ignition electrode can be measured in a simple manner.

It is a particular object of the present invention to provide solution to the above problems by a measuring device having the features as described herein.

Accordingly, the invention is characterized in a first aspect of the invention by a measuring device which includes at least one protective device in addition to an electronic measuring unit provided and designed to capture at least one measurement signal of an ignition electrode, which is arranged at least partially in a combustion chamber of a fluid-flow machine, the measurement signal being dependent on the measurement quantity. This protective device is designed to protect at least the electronic measuring unit of the measuring device from high voltages.

In one embodiment, the protective device is arranged between the ignition electrode and the electronic measuring unit. Furthermore, the measurement signal of the ignition electrode can, in an advantageous embodiment, be provided by an ammeter or voltmeter. The measuring device can thus, in accordance with a further aspect, include such a meter, which is arranged between the protective device and the electronic measuring unit. The measurement signal is in this case dependent on the measurement quantity.

High voltages are understood as ignition voltages which can be harmful to the electronic measuring unit. For example, ignition voltages of an ignition electrode can be damaging to the electronic measuring unit. Ignition electrodes used in combustion chambers usually have ignition voltages of several 1000 V.

In one embodiment, the measurement quantity on which the at least one measurement signal to be captured depends can include one of the following quantities. It can for example be an ion measurement quantity between two electrodes, where the ignition electrode includes at least one of the two electrodes. The ion measurement quantity can here be a measurement quantity dependent on ions. This includes, for example, an ion current or an ion voltage. Furthermore, this may include a voltage applied to the ignition electrode, a current applied to the ignition electrode, a resistance, an inductance, a capacitance, a shunt resistance and/or an impedance of the ignition electrode.

In one development, a measurement signal can thus be captured using the measuring device, said signal depending on one of the measurement quantities stated above.

In one embodiment, the protective device has at least one high-voltage diode. The high-voltage diode can be arranged between the ignition electrode and the electronic measuring unit such that the electronic measuring unit is protected from high voltages of the ignition electrode.

In a further embodiment, the protective device is provided with at least one transistor. In a further variant, the protective device has at least one relay. Both the transistor and the relay enable the protective device to switch between the electronic measuring unit and the voltage supply of the ignition electrode. With an embodiment of this type, the electronic measuring unit is protected from high voltages in that the electronic measuring unit is separated from the ignition electrode while a high voltage is applied to the ignition electrode.

In an advantageous embodiment, a measurement signal of the ignition electrode can be monitored almost continuously except for a few interruptions. These interruptions result during a brief period which is shorter than a second during the flash-over of the ignition electrode.

In a further embodiment, the measuring device includes at least one signal processing device. The signal processing device can, for example, be part of the electronic measuring unit. The measurement signal of the ignition electrode can be evaluated by the signal processing device. An evaluation signal can be provided by the signal processing device, said signal depending on the measurement signal.

In one exemplary embodiment, the measurement signal can be dependent on the state of the ignition electrode. The measurement signal can thus, for example, change due to the burn-off state of the ignition electrode or due to cracks in an insulator of the ignition electrode. A change of this type in the measurement signal can thus give an indication of the state of the ignition electrode. In one development, the evaluation signal can thus for example form an indicator for the state of the ignition electrode.

In a further aspect, the evaluation signal dependent on the measurement signal can be passed to a combustion control which can control the combustion process inside the combustion chamber depending on the evaluation signal.

In a further embodiment, the measuring device described above can be used such that a pressure inside the combustion chamber in the vicinity of the ignition electrode is determined. In this way, the measurement signal can change depending on pressure fluctuations inside the combustion chamber.

Furthermore, in accordance with a further aspect of the invention, the measuring device can be used to determine a temperature inside the combustion chamber. The measurement signal processed by the electronic measuring unit can be temperature-dependent.

It can further be provided that the ignition electrode is designed as a flame probe. Using the measuring device, it is possible in an embodiment of this type to determine whether there is a flame inside the combustion chamber. A flame inside the combustion chamber thus for example generates free charge carriers. These free charge carriers reduce a resistance at a spark gap of the ignition electrode. This means that when a flame is present, the resistance along the spark gap is lower than when the flame is out. Hence the measuring device can capture the presence of a flame in the combustion chamber.

In one development, the measurement signal can for example change depending on this resistance. This can in turn be captured by the electronic measuring unit.

In a further embodiment, the measuring device may include a trend monitor. The trend monitor can be equipped to capture the course of measurement signals. As a result, it is for example possible during repeated measurement of the same measurement quantity to capture a change of the measurement signal and hence also of the measurement quantity.

In one exemplary embodiment, the measurement signal or the evaluation signal can, for example, be compared with a filed limit value. In one development, a measure can be initiated, for example, when the limit value is exceeded. In a further embodiment, a measure can also be initiated when the limit value is not reached.

It is thus possible using the measuring device to detect at an early stage for example an impending failure of the ignition electrode. This allows counter-measures to be taken to ensure the reliability of the fluid-flow machine.

In an embodiment including a signal processing device, the measurement signal can be processed with a Fast Fourier analysis (FFT). Here, the analog measurement signal is first converted into a digital signal. The digital signal is then processed with an FFT. The result of the FFT can be analysed in a further embodiment and for example passed to a combustion control.

In one embodiment, processing of the measurement signal using the signal processing device is also possible without FFT. The analog measurement signal can thus for example be split into four signals. These four signals can be processed separately and then compared. It is for example possible in one design variant to detect whether there are high-frequency pressure fluctuations (known as rumble) inside the combustion chamber.

According to a further aspect of the invention, the measurement quantity can be determined depending on a field of characteristics. The field of characteristics can depend here on a pressure, a temperature and/or a speed. In particular, these can be the pressure and the temperature inside the combustion chamber. The speed can in particular be the speed of a turbine shaft.

A field of characteristics can for example exist in the form of a reference table. In one design variant, the field of characteristics can be used to determine the measurement quantity.

For example, in one embodiment a correction of the determined measurement quantity can be performed based on a field of characteristics.

It must be understood that in one embodiment, the fluid-flow machine which includes the combustion chamber is an aircraft engine. Further embodiments can also for example relate to a gas turbine.

### BRIEF DESCRIPTION OF THE DRAWINGS

Further details and advantages of the present invention become apparent from the following description of exemplary embodiments shown in the figures.

FIG. 1 shows the basic structure of a combustion chamber of a fluid-flow machine having an ignition electrode and a measuring device.

FIG. 2 shows a schematic representation of a first embodiment of a measuring device connected to an ignition electrode, which is individually insulated against earth.

FIG. 3 shows a schematic representation of a second embodiment of the measuring device connected to an ignition electrode, which is individually insulated against earth.

FIG. 4 shows a schematic representation of a third embodiment of the measuring device connected to an ignition electrode, which is individually insulated against earth.

### DETAILED DESCRIPTION

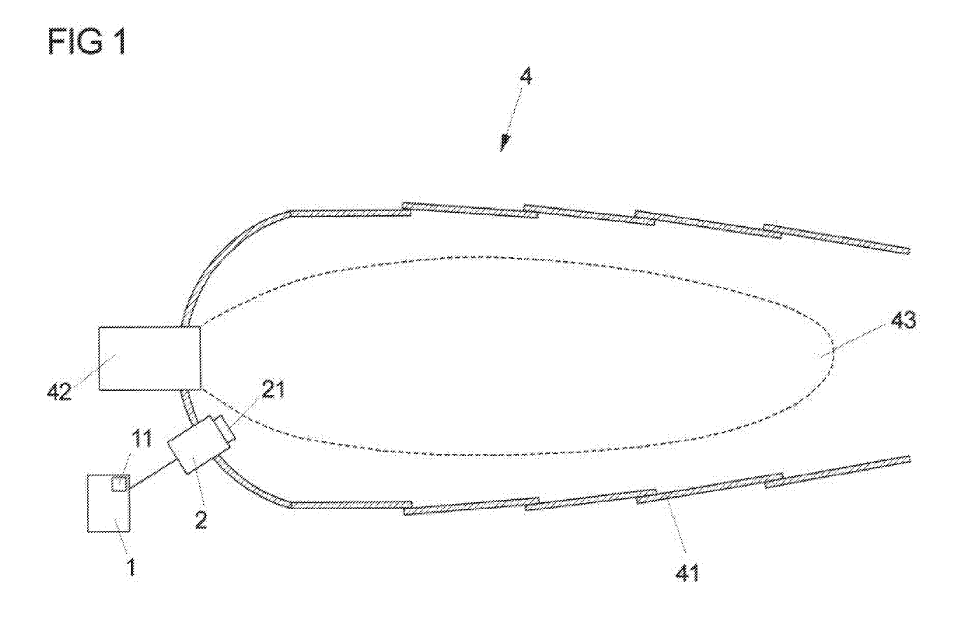

FIG. 1 schematically shows an arrangement including a combustion chamber 4, a measuring device 1, an ignition electrode 2 and a burner 42. During operation, a combustion zone 43 extends from the burner 42 inside the combustion chamber 4. The combustion chamber 4 is limited by a combustion chamber wall 41. An ignition electrode 2 is arranged on the combustion chamber 4 such that one electrode 21 of the ignition electrode 2 is arranged at least partially inside the combustion chamber 4. The measuring device 1, which includes an electronic measuring unit 11, is connected to the ignition electrode 2. The ignition electrode 2 can ignite a combustion mixture located in the interior of the combustion chamber 4 with an ignition spark. In the exemplary embodiment shown here, the ignition electrode 2 projects through the combustion chamber wall 41 into the combustion chamber 4.

A measurement signal of the ignition electrode 2 can be captured using the measuring device 1. The measurement signal is here dependent on a measurement quantity of the ignition electrode 2. Generating the ignition spark by means of the ignition electrode 2 requires the application of a high voltage to the ignition electrode 2. This can involve voltages of more than 1000 V. The measuring device 1 therefore includes a protective device 12 which protects at least the electronic measuring unit 11 from such high voltages.

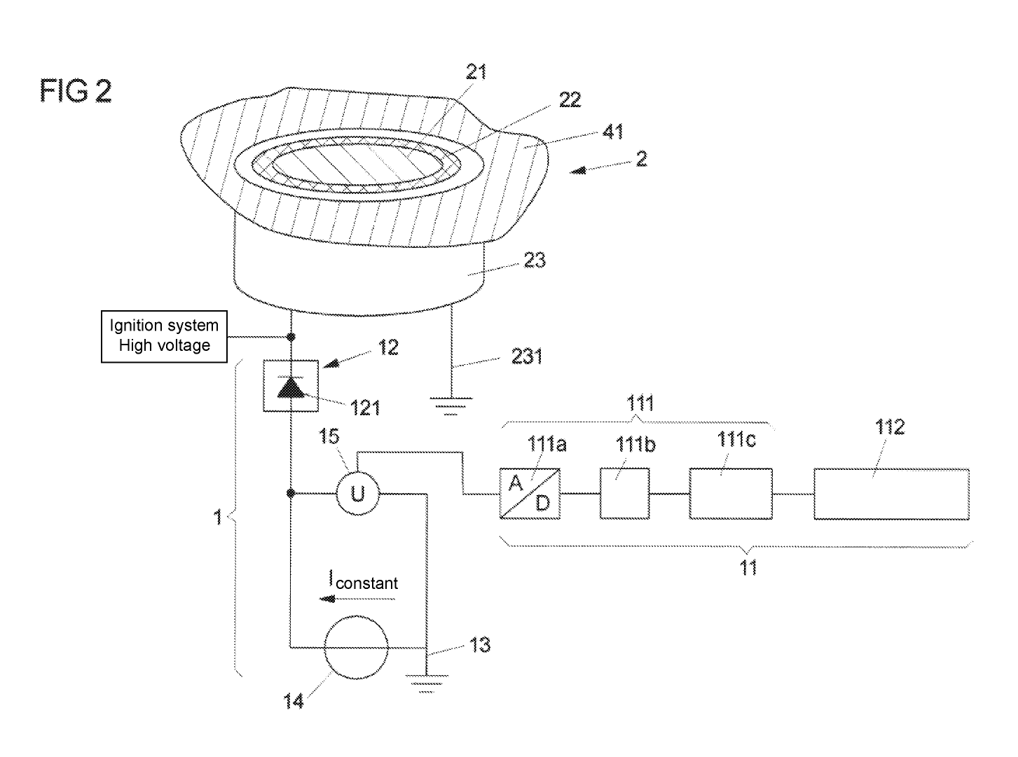

FIGS. 2 to 4 show in schematic form more detailed embodiments of the measuring device 1 connected to an ignition electrode 2.

FIG. 2 schematically shows a first embodiment of this type. In this embodiment, the ignition electrode 2 includes a single electrode 21 made for example from tungsten. The ignition electrode 2 projects here through the combustion chamber wall 41 into the interior of the combustion chamber 4. The rod-shaped electrode 21 is surrounded by an insulator 22. The insulator 22 insulates the electrode 21 electrically from a casing 23. Said casing 23 has an earth connection 231 and is integrated into the combustion chamber wall 41. The electrode 21 is thus individually insulated against earth.

The electrode 21 is connected in electrically conducting manner to the measuring device 1. The measuring device 1 includes a protective device 12, which is connected to the electrode 21 as the first electrical component of the measuring device 1. The protective device 12 is therefore arranged between the electrode 21 belonging to the ignition electrode 2 and all further elements of the measuring device

In this exemplary embodiment, the protective device 12 includes a high-voltage diode 121. The high-voltage diode 121 is arranged here such that high voltages possibly applied to the electrode 21 do not endanger the electronic measuring unit 1.

The electronic measuring unit 1 includes furthermore a constant current source 14. The constant current source 14 supplies the electrode 21 of the ignition electrode 2 with a constant current against earth. The constant current source 14 is thus connected to the ignition electrode 2 at a connection via the high-voltage diode 121. At its second connection, it is connected to earth via an earth connection 13.

The measuring device 1 also includes a voltmeter 15 which is arranged such that it can measure voltages applied to the electrode 21 against earth. A measurement signal is thus provided by the voltmeter 15. The voltage measured by the voltmeter 15 can depend on differing measurement quantities of the ignition electrode 2. The voltage measured by the voltmeter 15 can be further processed as a measurement signal in one embodiment.

The measurement signal provided by the voltmeter 15 can be further processed by an electronic measuring unit 11. The electronic measuring unit 11 is arranged here such that it receives the measurement signal of the voltmeter 15 as an input signal.

In further embodiments, the measurement signal can also be provided by an ammeter instead of a voltmeter 15. Instead of a constant current source, a constant voltage source would have to be used here. The appropriate connections of the constant voltage source and of the ammeter would have to be adjusted.

In the embodiment here shown, the electronic measuring unit 11 includes a signal processing device 111 and a combustion control 112. The combustion control 112 is arranged here behind the signal processing device 111, meaning that the combustion control 112 receives a signal of the signal processing device 111 as an input signal.

The signal processing device 111 includes an analog/digital converter 111a, an FFT analysis means 111b, as well as an evaluation unit 111c. The analog/ digital converter 111a converts the analog-measured voltage signal into a digital signal. The digital signal is subjected to an FFT with the FFT analysis means 111b. The evaluation unit 111c further processes this signal and provides an evaluation signal.

This evaluation signal can be passed to a combustion control 112. The combustion control 112 can then, depending on the evaluated voltage signal, set combustion parameters of the combustion chamber 4.

In further embodiments, impedance characteristic values of the ignition electrode 2 can for example be determined from the measurement signal using the electronic measuring unit 11. The state of the ignition electrode 2 can thus be determined, for example, by a resistance measurement. This allows a failure of the ignition electrode 2 to be predicted at an early stage.

In other developments, it is also possible to determine, among others, an ion measurement quantity between two electrodes, where the ignition electrode 2 includes at least one electrode 21, a voltage applied to the ignition electrode 2, a current applied to the ignition electrode 2, a resistance, an inductance, a capacitance and/or a shunt resistance of the ignition electrode. In one embodiment, the ion measurement quantity can include an ion current and/or an ion voltage.

In one development, it is also possible to expand the electronic measuring unit 11 with a trend monitor. This enables multiple measurements to be captured using the electronic measuring unit 11, and changes in the measurement signal to be captured.

In general, the measurement signal can be captured discretely or continuously.

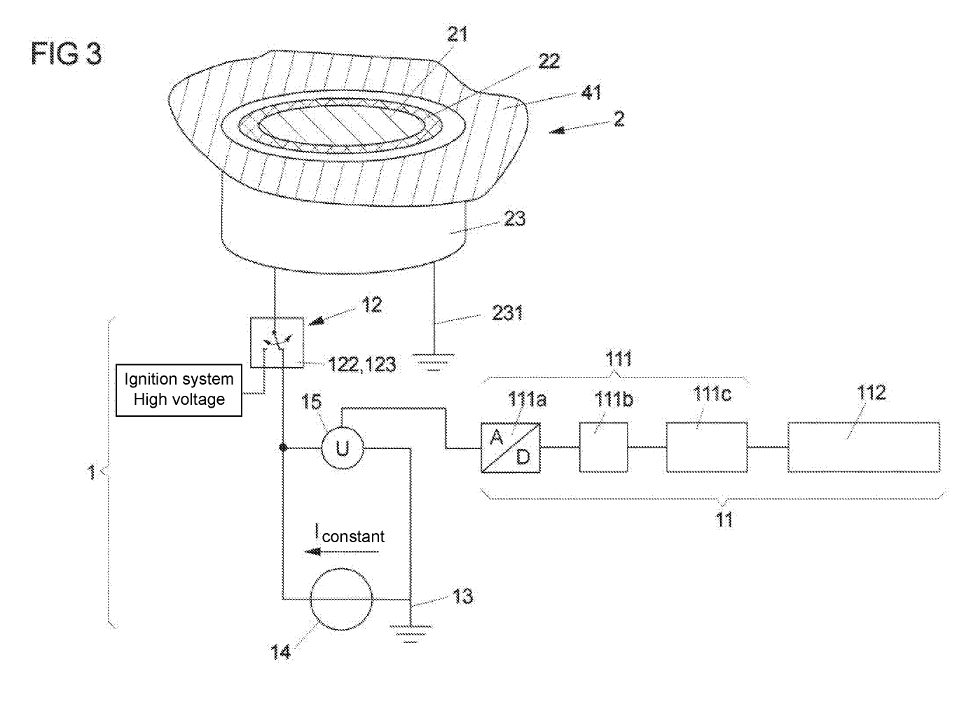

FIG. 3 shows a second embodiment of the measuring device in accordance with the invention. This is an arrangement which is identical to the arrangement from FIG. 2 except for one component. The component which differs from FIG. 2 is the protective device 12.

In this embodiment, the protective device 12 is designed as a switching element. The protective device 12 is again arranged between the ignition electrode 2 and all further components of the measuring device 1.

The switching element can for example be designed as a transistor 122 or relay 123. It permits switchover between a high-voltage supply for generating an ignition spark with the electrode 21 and the measuring device 1. Here too, at least the electronic measuring unit 11 of the measuring device 1 is protected from high voltages, since the high voltage and the electronic measuring unit 11 are never simultaneously connected to the ignition electrode 2.

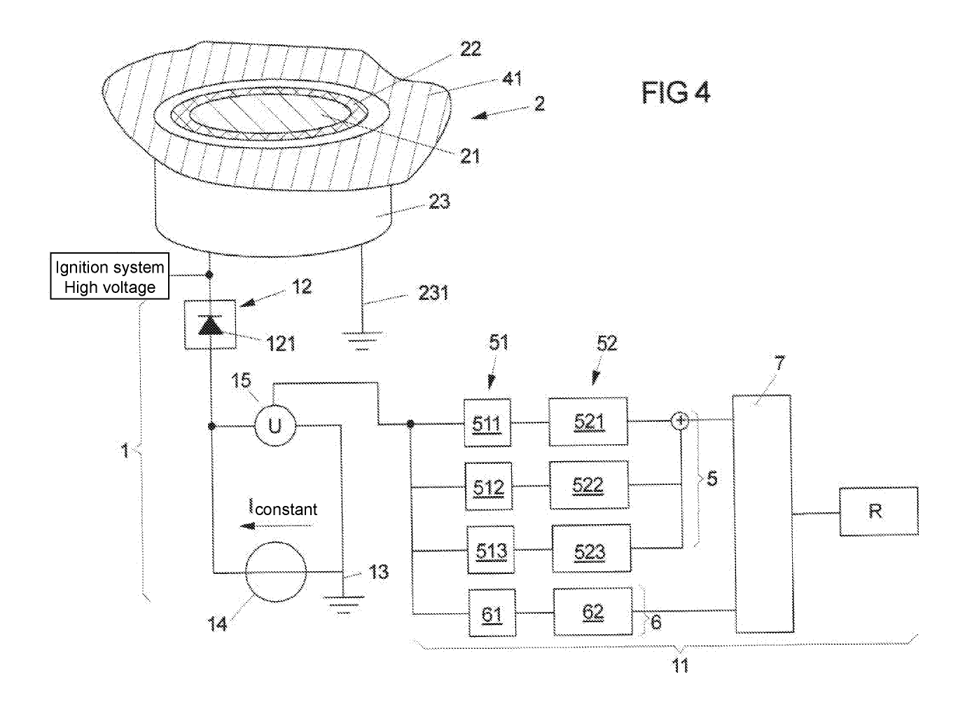

FIG. 4 shows a further embodiment of the invention. It is substantially the arrangement already shown in FIG. 2 and differs only in that the electronic measuring unit 11 is of differing design.

The electronic measuring unit 11 shown here does not include an FFT analysis means for performing a computation-intensive FFT analysis. The electronic measuring unit 11 here shown is for example provided and designed to capture a high-frequency pressure fluctuation, also called rumble, inside the combustion chamber 4.

The measurement signal provided by the voltmeter 15 is split into four identical signal lines. Three signal lines are passed to a first analysis device 5 and one signal line is passed to a second analysis device 6. Both the first analysis device 5 and the second analysis device 6 each generate an evaluation signal. The two evaluation signals are then passed to a comparator 7 which generates a rumble signal R. The rumble signal R is an indicator of whether rumble is present.

In the first analysis device 5, the three signal lines then first lead to a bandpass filter group 51 and afterwards to an RMS converter group 52. The RMS converter group 52 is designed to form an effective value (root mean square value) for each of the three signals of the bandpass filter group 51. The three signals of the RMS converter group 52 are added up to an evaluation signal of the first analysis device 5.

In the second analysis device 6, the fourth signal line is first passed to a bandstop filter 61 and then to an RMS converter 62. The signal generated by the RMS converter 62 forms the evaluation signal of the second analysis device 6.

The bandpass filter group 51 includes a bandpass filter for each of the three signal lines. The first bandpass filter 511 filters out a basic frequency of the rumble, the second bandpass filter 512 filters out a first harmonic of the rumble, and the third bandpass filter 513 filters out a second harmonic of the rumble.

The filtered signals are each processed in the RMS converter group 52 using an RMS converter 521, 522, 523. The RMS converters each form an effective value of the filtered signals. Then the three effective values are added up to an evaluation signal of the first analysis device 5.

In the second analysis device, the bandstop filter 61 stops the basic frequency, first harmonic and second harmonic of the rumble. The resulting signal is processed in the RMS converter 62 into an effective value. This effective value forms the evaluation signal of the second analysis device 6.

In the comparator 7, the first evaluation signal of the first analysis device 5 and the second evaluation signal of the second analysis device 6 are compared. From this comparison it can be deduced whether rumble is present. This can be indicated by a rumble signal R.

It must be noted that in further embodiments, the various designs of the protective device 12 can be combined and interchanged with one another.

The invention in its design is not restricted to the above mentioned exemplary embodiments, which are to be understood only as examples. The embodiments of the ignition electrode and of the protective device, for instance, are to be understood only exemplarily.

1. A measuring device for a measurement quantity, including an electronic measuring unit provided and designed to capture at least one measurement signal of an ignition electrode, which is arranged at least partially in a combustion chamber of a fluid-flow machine, the measurement signal being dependent on the measurement quantity, wherein
the ignition electrode is provided and designed as a flame probe, that wherein at least one protective device is provided to protect at least the electronic measuring unit from high voltages, that wherein the measuring device includes at least one signal processing device, which is provided and designed to evaluate the at least one measurement signal of the ignition electrode and to provide at least one evaluation signal, and that at least one evaluation signal is provided as an indicator for the state of the ignition electrode.

2. The measuring device in accordance with claim 1, wherein the at least one measurement quantity includes at least one ion measurement quantity between two electrodes, where the ignition electrode includes at least one electrode, a voltage applied to the ignition electrode, a current applied to the ignition electrode as well as an impedance, a resistance, an inductance, a capacitance and/or a shunt resistance of the ignition electrode.

3. The measuring device in accordance with claim claim 1, wherein the protective device includes at least one high-voltage diode.

4. The measuring device in accordance with claim 1, wherein the protective device includes at least one transistor.

5. The measuring device in accordance with at claim 1, wherein the protective device includes at least one relay.

6. The measuring device in accordance with claim 1, wherein the measurement signal can be processed by the signal processing device without a Fast Fourier analysis.

7. The measuring device in accordance with claim 1, wherein the measurement signal can be processed by the signal processing device with at least one bandpass filter and one comparator.

8. The measuring device in accordance with claim 1, wherein the measurement signal can be processed by the signal processing device with a Fast Fourier analysis.

9. The measuring device in accordance with claim 1, wherein the measuring device includes a trend monitor to capture a course of measurement signals.

10. The measuring device in accordance with claim 1, wherein the measuring device includes a combustion control.

11. The measuring device in accordance with of claim 1, wherein a pressure inside the combustion chamber in the vicinity of the ignition electrode can be determined by the measuring device.

12. The measuring device in accordance with claim 1, wherein a temperature inside the combustion chamber in the vicinity of the ignition electrode can be determined by the measuring device.

13. The measuring device in accordance with claim 1, wherein the measurement quantity can be determined depending on a field of characteristics, which depends at least on speed, temperature and/or pressure.
